(19) United States
(12) Patent Application Publication
(10) Pub. No.: US 2017/0096269 A1
(43) Pub. Date: Apr. 6, 2017

(54) BAND CLAMP WITH IMPROVED BUCKLE

(71) Applicant: Band-It-IDEX, Inc., Denver, CO (US)

(72) Inventor: Miklos Balazs Marelin, Aurora, CO (US)

(21) Appl. No.: 15/282,685

(22) Filed: Sep. 30, 2016

Related U.S. Application Data
(60) Provisional application No. 62/236,367, filed on Oct. 2, 2015.
(60) Provisional application No. 62/350,408, filed on Jun. 15, 2016.

(51) Int. Cl. B65D 63/08; B65D 63/04; F16B 2/08

(52) U.S. Cl. CPC B65D 63/08; F16B 2/08; B65D 63/04

(57) ABSTRACT

An improved band clamp is provided that employs a punch that forms an indication in the deformed band during locking procedure. Bands are provided with one or more protrusions to provide a band with the ability to expand and thereby indicate to a user that a deformation or change in an associated object has occurred. The protrusions are provided such that a failure point of the device is preferably positioned at the band clamp.

This U.S. Non-Provisional Patent Application claims the benefit of priority from U.S. Provisional Patent Application Ser. No. 62/236,367, filed Oct. 2, 2015, and U.S. Provisional Patent Application Ser. No. 62/350,408, filed Jun. 15, 2016, the entire disclosures of which are hereby incorporated by reference.

### FIELD OF THE INVENTION

Embodiments of the present invention are generally related band buckles and bands for securing objects. More specifically, embodiments of the present invention provide a band buckle device adapted to receive and secure a band including, but not limited to, a metal band or strap.

### BACKGROUND OF THE INVENTION

In the art of securing members together it has long been the practice to employ a strap or band of metal which encircles or otherwise extends about a member or members, or a plurality of articles in a bundle, which is tensioned and its ends then secured together with a locking member, variously referred to as a seal, sleeve, or buckle. The buckle is commonly formed of ductile sheet material, such as steel, which is bent into the form of a tube having a rectangular channel in which the band ends are disposed in lapped relation after which a cold crimping or swaging action locks the buckle and band ends together. In one form of conventional lock, portions of the band edges are sheared and bent laterally to provide locks engageable with corresponding apertures or sheared portions in the buckle, an example of which is disclosed in U.S. Pat. No. 1,988,742, which is hereby incorporated by reference in its entirety. As will be apparent, the cross section of the band is reduced at its transverse points where the shear locks or lugs occur, the strength of the band in tension is reduced.

In another form of lock, as exemplified by U.S. Pat. No. 190,641, which is hereby incorporated by reference in its entirety, the band is not weakened by shearing portions of its cross section. Rather, a suitable aperture is provided in the buckle into which the band is crimped, forming a lock, but maintaining the cross section of the band essentially the same as prior thereto.

Band clamps are used to bundle a plurality of objects or to attach one object to another and comprise a band with an interconnected buckle (sometimes referred to as a seal). The band is wrapped around the object or objects, a free end of the band is inserted into the buckle, the band is tensioned, and the buckle is interconnected to the band to maintain band tension. A hand-held tool is often used to tension the band and to fix the buckle to the band. The tool is used to remove excess band after the band clamp is locked. Such tools commonly employ a ratcheting mechanism that rotates a winding mandrel that tensions the band.

U.S. Pat. No. 3,641,629 to Beardsley, which is hereby incorporated by reference in its entirety, discloses a band buckle, a method of making the same, and a method of applying a band buckle. Various features and tools provided in Beardsley '629 are contemplated for use within embodiments of the present disclosure. Beardsley '629 fails to disclose, however, various features of the present inventions including, for example, devices and methods for securing a band and band buckle

U.S. patent application Ser. No. 15/269,333, which is hereby incorporated by reference in its entirety, discloses a band clamping tool. Devices and features shown and described in application Ser. No. 15/269,333 are contemplated use with devices of the present disclosure.

U.S. Pat. No. 8,424,166 to Dorneman et al., which is hereby incorporated by reference in its entirety, discloses a locking band clamp, a locking tool and a method of forming a locking band clamp. Various features and devices shown and described in U.S. Pat. No. 8,424,166 to Dorneman et al. are contemplated for use with embodiments of the present invention.

### SUMMARY OF THE INVENTION

It is one aspect of embodiments of the present invention to provide a band clamp with a buckle for receiving a band, the buckle comprising an aperture through an outer surface of the buckle. A band is positioned within the buckle, and a deformation is formed in the band and located generally adjacent to the aperture, the deformation preventing relative motion between the band and the buckle. A curled portion of the band is provided and engages an edge of the outer surface of the buckle to prevent relative motion of the buckle relative to the band. The band comprises a length and at least one profrusion is provided on the length and distal from the buckle, the protrusion comprising at least one of a bend and a step and wherein the protrusion comprises a departure from a general path of the band.

In another embodiment, a band damp system is provided, the system comprising a buckle for receiving a band, the buckle comprising at least one peripheral opening for receiving the band, and an aperture provided through an outer surface of the buckle. A band is positioned within the buckle, and the aperture of the buckle comprises an aperture sidewalk the aperture sidewall operable to be provided in force-transmitting communication with the band to prevent relative motion of the buckle relative to the band. The band comprises a length and at least one protrusion is provided on the length and distal from the buckle, the protrusion comprising at least one of a bend and a step and wherein the protrusion comprises a departure from a general path of the band.

In various embodiments, methods of providing and applying a clamp are provided. In one embodiment, a method of securing an object with a band clamp is provided, the method comprising: providing a buckle for receiving a band, the buckle comprising: an aperture through an outer surface of the buckle, and a band positioned within the buckle; and the band comprising a length and at least one protrusion provided on the length and distal from the buckle, the protrusion comprising at least one of a bend and a step and wherein the protrusion comprises a departure from a general path of the band; providing the band around an object to be secured; inserting a first end and a second end of the band into the buckle; providing a deformation in the band proximal to the buckle, and wherein the deformation provides force-transmitting communication between the band and the buckle; and monitoring the at least one protrusion of the band to determine of the object has experienced a movement or a deformation.

In various applications, it may be desirable to provide a band clamp that is capable of providing a visual indication that a deformation has occurred and wherein this visual indication occurs prior to a catastrophic failure of the buckle. For example, various pressure vessels and pipes may be secured using band clamp systems of the present invention. In various embodiments, band clamps systems of the present invention comprise bands having at least one protrusion in an original or un-deformed state. The continued presence of the at least one protrusion generally indicates that the band and associated object has not been deformed. If, however, the protrusions have deformed, stretched out, or otherwise been altered, such an occurrence indicates a change or problem with the associated object. For example, where the band and clamp are provided around a pipe or a flush cartridge of a toilet, the flattening or change of the protrusion in the band indicates that the pipe or flush cartridge has been compromised and may need replacement or repair. In preferred embodiments, such a flattening or change in the protrusion occurs prior to a failure of the band and/or buckle. Preferably, a weak point or failure point is provided at the buckle, but the band and buckle comprise a structural integrity even subsequent to a change in the protrusion(s) of the band.

The Summary of the Invention is neither intended nor should it be construed as being representative of the full extent and scope of the present invention. That is, these and other aspects and advantages will be apparent from the disclosure of the invention(s) described herein. Further, the above-described embodiments, aspects, objectives, and configurations are neither complete nor exhaustive. As will be appreciated, other embodiments of the invention are possible using, alone or in combination, one or more of the features set forth above or described below. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. Additional aspects of the present invention will become more readily apparent from the Detail Description, particularly when taken together with the drawings.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a front perspective view of a buckle according to one embodiment of the present invention.

FIGS. 2A-2B are perspective views of a buckle and a band according to one embodiment of the present invention.

FIG. 3 is a cross-sectional perspective view of a buckle and a band according to one embodiment of the present invention.

FIG. 4 is a perspective view of a buckle and a band according to one embodiment of the present invention.

FIGS. 5A-5B are cross-sectional perspective views of a buckle and a band according to the embodiment of FIG. 4.

FIG. 6 is a perspective view of a buckle and a band according to one embodiment of the present invention.

FIG. 7 is a cross-sectional perspective view of the embodiment of FIG. 6.

FIG. 8 is a cross-sectional perspective view of the embodiment of FIG. 6.

FIG. 9 is a cross-sectional perspective view of the embodiment of FIG. 6.

FIG. 10 is a perspective view of a buckle according to one embodiment of the present disclosure.

FIG. 11 is a plan view of the buckle according to the embodiment of FIG. 10.

FIG. 12 is a side elevation view of the buckle according to the embodiment of FIG. 10.

FIG. 13 is a detailed view of a strap feature suitable for use with the buckle shown in FIG. 10.

FIG. 14A is a plan view of a buckle and a strap according to one embodiment of the present invention.

FIG. 14B is a detailed view of a component of the embodiment of FIG. 14A.

FIG. 15 is a perspective view of a band and buckle according to one embodiment of the present invention.

FIG. 16 is a perspective view of a plurality of bands and clamps according to at least one embodiment of the present invention.

FIG. 17 is a perspective view of a band and a clamp according to one embodiment of the present invention and wherein the band is secured to an object.

FIG. 18 is a graph showing performance characteristics of various embodiments of the present invention.

FIG. 19 is a plan view depicting a buckle and strap according to one embodiment of the present invention.

To assist in the understanding of one embodiment of the present invention the following list of components and associated numbering found in the drawings is provided herein:

| # | Component |
|---|---|
| 2 | Buckle |
| 4 | Upper Portion |
| 6 | Lower Portion |
| 7 | Peripheral Opening |
| 8 | Gap |
| 10 | Bend |
| 12 | Aperture |
| 13 | Aperture Sidewall |
| 14 | Band |
| 15 | Curled Edge |
| 16 | Deformation |
| 18 | First Sheared Edge |
| 20 | Second Sheared Edge |
| 22 | Third Sheared Edge |
| 24 | Fourth Sheared Edge |
| 26 | Sheared Edge |
| 30 | Buckle |
| 32 | Bend |
| 34 | Peripheral Opening |
| 36 | Aperture |
| 38 | Aperture |
| 40 | Band |
| 42 | Deformation |
| 50 | Attachment Member |
| 52 | Buckle |
| 54 | Band |
| 55 | First End |
| 56 | Second End |
| 58 | Protrusion |
| 60 | Step |
| 62 | Deformation |
| 64 | Object |

It should be understood that the drawings are not necessarily to scale. In certain instances, details that are not necessary for an understanding of the invention or that render other details difficult to perceive may have been omitted. It should be understood, of course, the invention is not necessarily limited to the particular embodiments illustrated herein.

### DETAILED DESCRIPTION

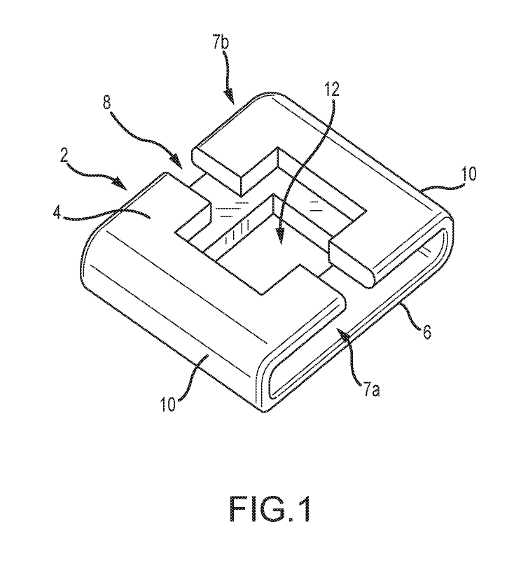

FIG. 1 shows a buckle 2 according to one embodiment of the present invention that comprises an upper portion 4 and a lower portion 6. In some embodiments, the buckle 2 is formed from a single sheet of metal and is provided in the shape shown in FIG. 1 by providing a first and second bends 10 wherein the bends 10 serve as a transition point between the upper portion and the lower portion 4, 6. The upper portion 4, lower portion 6, and bends 10 generally comprise an outer surface, and an at least partially confined internal volume is provided for receiving a band or a strap, for example.

One or more gaps 8 are provided in the upper portion 4. The gap 8 may be of various dimensions, and no limitation with respect to size of gap and/or the proportions of the gap 8 with respect to additional buckle features is provided herewith. The buckle 2 further comprises a central aperture 12. The central aperture 12 is provided as a rectilinear aperture in the embodiment shown in FIG. 1, but may comprises various different geometric shapes including, but not limited, circular shapes, triangular shapes, and irregular shapes. The buckle 2 also comprises first and second peripheral openings 7a, 7b. The peripheral openings 7a, 7b are adapted to and operable to receive a band or strap (not shown in FIG. 1).

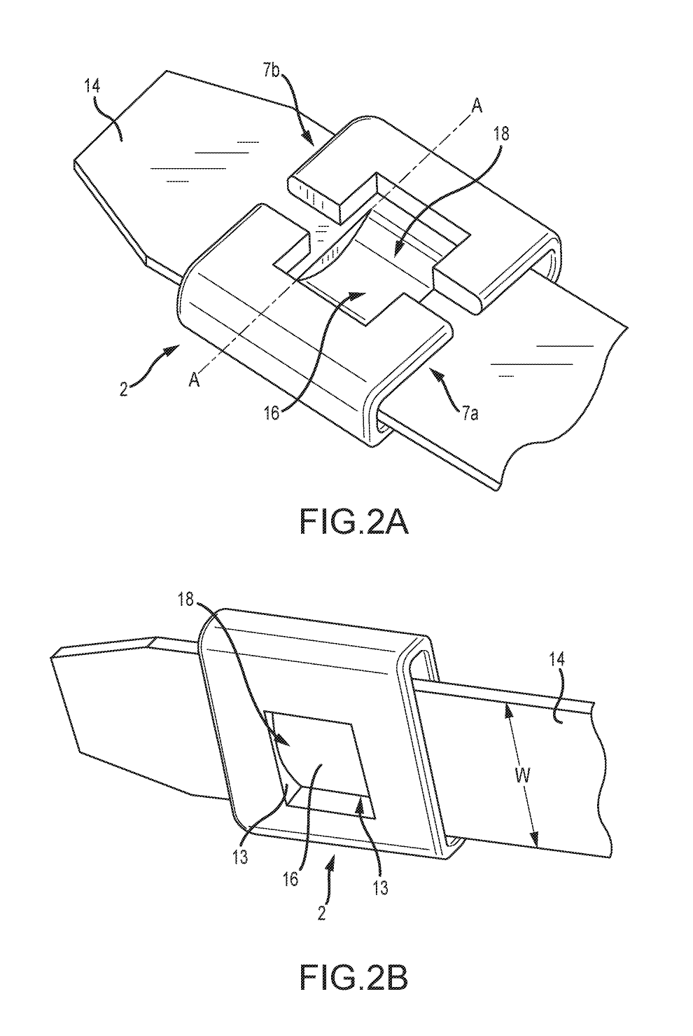

FIGS. 2A-2B are top and bottom perspective views of the buckle 2 according to the embodiment of FIG. 1. As shown, a band 14 extends into and/or through the buckle and is secured by means of the buckle 2. Specifically, the band 14 is disposed within the buckle 2 and extends through at least one of the first and second peripheral openings 7a, 7b. The band 14 comprises a thickness that is sufficiently small to be accommodated between the upper and lower portions 4, 6 of the buckle. In some embodiments, the band 14 originally comprises a substantially smooth or flat band to facilitate insertion of at least a portion of the band 14 into the buckle 2. Once the band 14 is provided in a desired position relative to the buckle, the band 14 is deformed to secure this desired position. In various embodiments, a method of positioning of the band 14 comprises applying a tension to the band and/or securing the band around an additional object (e.g. a sign post, pipe, cables, etc.). A punch or similar tool is used to deform a portion of the band 14, and a deformation 16 is provided on the band 14 and within an area or volume defined by the buckle. The deformation 16 of FIGS. 2A-2B comprises a trough-shaped feature that generally comprises a depression in the view of FIG. 2A, and which extends downwardly. The deformation 16 in the band 14 results in at least a first sheared edge 18 with a substantially flat or planar surface provided adjacent to a sidewall 13 of the aperture 12. As shown in FIGS. 2A-2B, the deformation 16 comprises first and second sheared edges 16, 18 provided adjacent to and/or in contact with opposing sidewalls 13 of the aperture. The provision of first 18 and second 20 sheared edges provided that the band 14 is translationally fixed with respect to the buckle 2, at least after the deformation 16 is provided in the band 14.

As shown in FIGS. 2A-2B, and as will be recognized by one of ordinary skill in the art, the deformation 16 extends across only a portion of the width W of the band 14. Extending the deformation 16 across an entirety of the width W of the band 14 would sever the band 14 and fail to provide a connection.

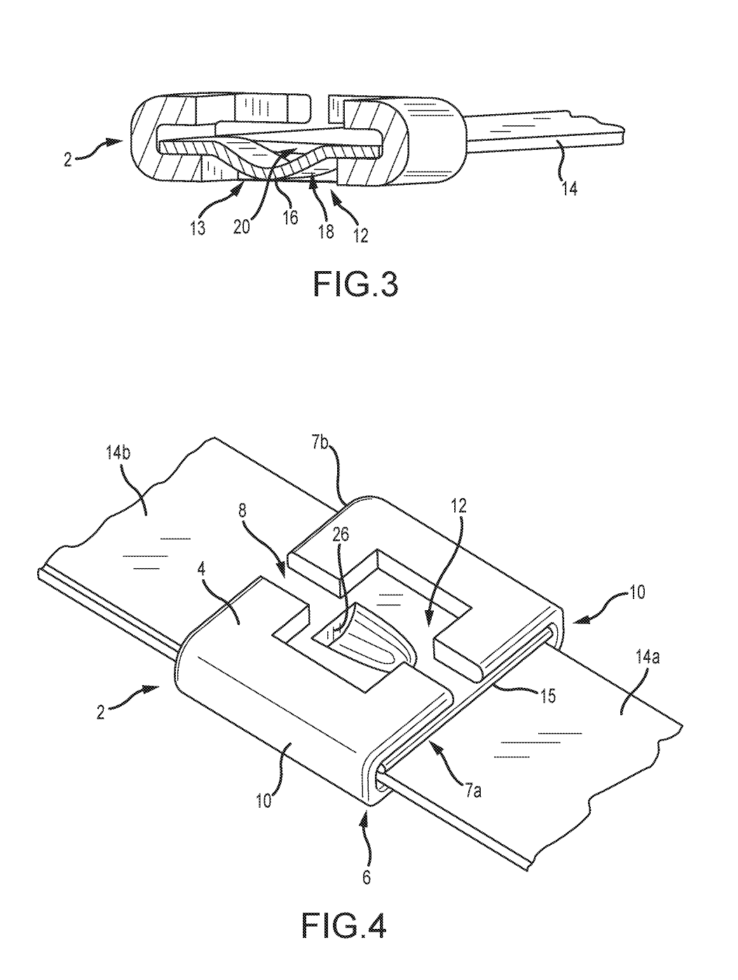

FIG. 3 is a cross-sectional perspective view of the buckle 2 and band 14 according to the embodiment of FIGS. 1-2B, and taken at line A-A of FIG. 1. As shown in FIG. 3, the buckle 2 is provided with a band 14 at least partially inserted therein. The band 14 is provided with a deformation 16, that is formed with a punch or similar tool. The deformation 16 comprises a cut or first sheared edge 16 on one side of the deformation and a second sheared edge 18 on a second side of the deformation 16. The sheared edges 16, 18 comprise substantially planar surfaces that operate as contact surface or force-transmitting surfaces to secure the band 14 to the buckle 2 by interaction and contact with sidewalls 13 of the aperture 12. As shown in FIG. 3, an upper portion of the aperture 12 is operable to receive a tool (not shown), and the lower portion of the aperture 12 receives the deformation 16. It will be recognized, however, that this arrangement could be reversed, and the deformation may comprise an upwardly-extending deformation.

FIG. 4 is perspective view of a buckle 2 and associated band 14 according to another embodiment of the present invention. As shown in FIG. 4, the buckle comprises the same construction as the buckle 2 provided in FIG. 1. First and second ends of the band 14 are positioned within the buckle. Although not shown in FIG. 4, the band 14 is looped or wrapped around one or more objects, and secured by means of the buckle 2. Accordingly, a first end 14a of the band 14 extends from one end of the buckle, and a second end 14b of the band extends from a second end of the buckle. The band 14 is secured within the buckle, and the shape of band is thus fixed, by providing a deformation 16 on the band 14 and on a portion of the band that is disposed at least partially within the buckle 2. The deformation 16 provided in FIG. 4 comprises a preferred shape, with a sheared edge 26 provided on one end of the deformation 16 and a tapered shape extending away from the sheared edge 26.

As also shown in FIG. 4, the second end 14b of the band comprises a curled edge 15 to provide additional securement of the band 14 to the buckle 2. Although not shown in FIG. 4, the first end 14a of the band 14 is also contemplated as comprising a curled edge adjacent to a portion of the buckle. A curled edge on the first end 14a of the band 14 may be provided in addition to or in lieu of the curled edge 15 provided on the second end 14b of the band 14.

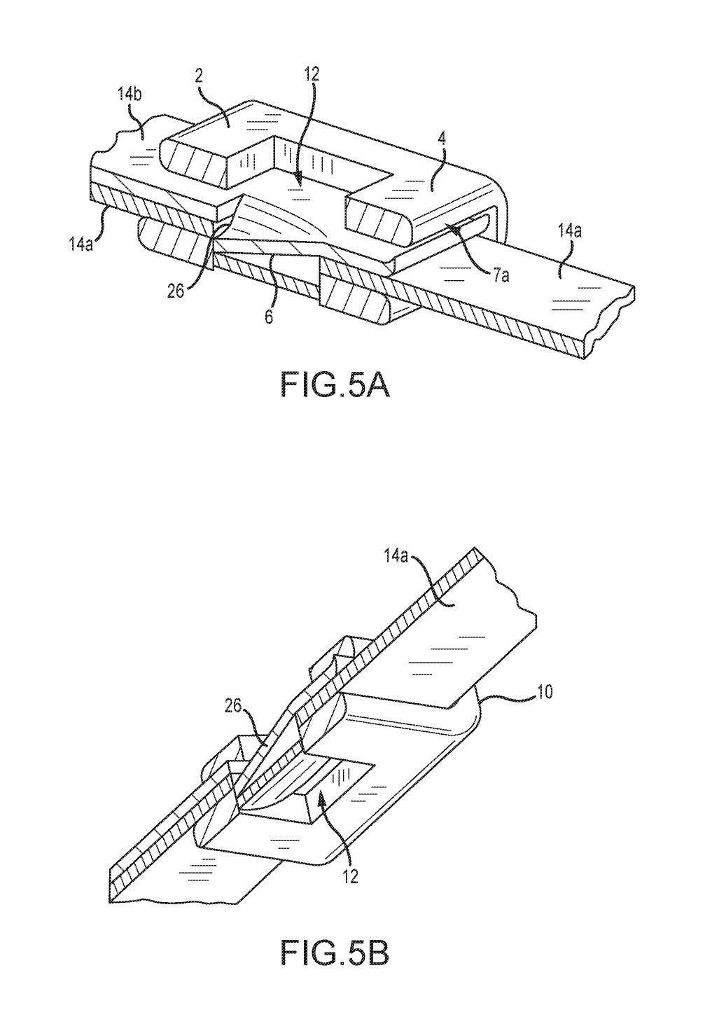

FIG. 5A is a cross-sectional perspective view of a buckle 2 and strap according to the embodiment of FIG. 4. As shown, a first end 14a and a second end 14b of the band 14 are passed through the buckle 2. A portion of the band 14 that is generally disposed within the buckle 2 is then deformed to create a deformation 16. The deformation 16 is preferably formed by providing a punch or similar tool in contact with an upper portion of the band 14 and through the aperture 12 on the upper portion of the buckle 2. The aperture 12 on the upper portion of the buckle 12 serves as a guide member for contacting the band 14 with a tool and creating this deformation 16. As shown in FIGS. 5A-5B, a portion of both the first end 14a and the second end 14b of the band 14 that is disposed within the buckle 2 is deformed such that sheared edges of the band 14 are provided in contact with an aperture sidewall. The first end 14a and the second end 14b are thereby secured relative to the buckle 2 and relative to each other. One of ordinary skill in the art will thus realize that the band is thereby secured around an object that the band surrounds (not shown in FIGS. 5A-5B).

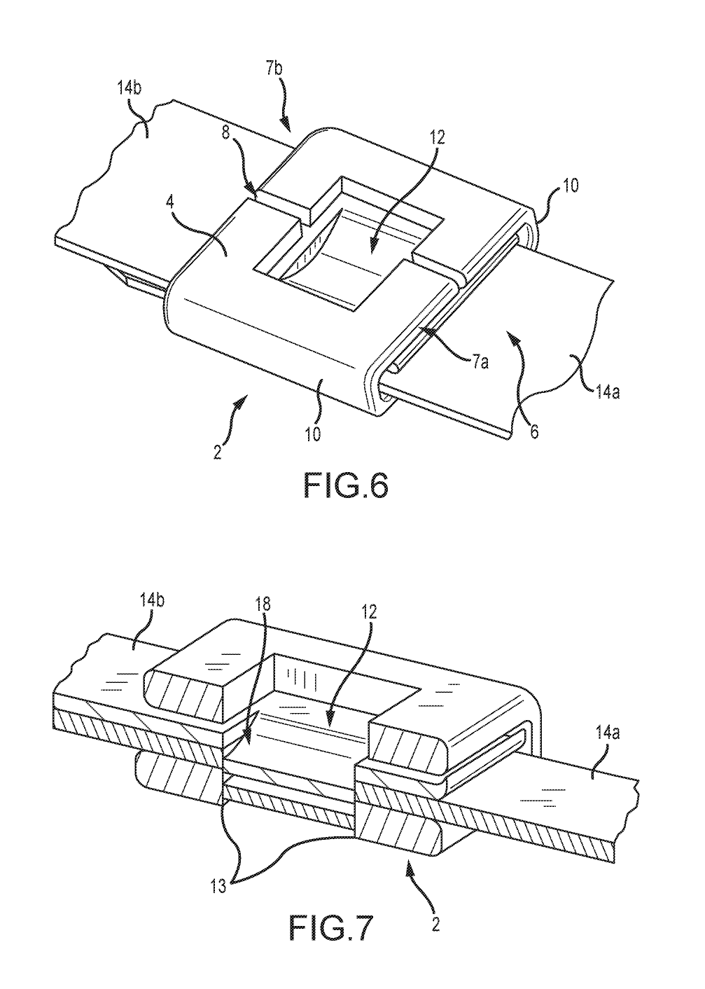

FIG. 6 is a top perspective view of a buckle 2 and associated band 14 according to one embodiment of the present invention. The buckle 2 of FIG. 6 comprises substantially the same construction as the buckle 2 of FIG. 1. As shown in FIG. 6, the band comprises a first end 14a and a second end 14b. The band extends in a loop (not shown in FIG. 6) such that the band 14 may be passed around and/or encircle an additional object. Opposing ends 14a, 14b of the band 14 are inserted into opposing sides of the buckle 2 and are provided in an overlapping arrangement. Once the band 14 is provided in a desired orientation with at least a portion of the first end 14a and/or the second end 14b provided within the buckle 2, the band 14 is deformed to secure the band to the buckle 2.

Specifically, and as shown in FIG. 6, the first end 14a and the second end 14b of the band 14 are inserted into opposing sides of the buckle 2 and are provided in an overlapping arrangement. A punch or similar tool is preferably used to deform, bend, and/or shear a portion of the band, the portion comprising a deformation 16 that extends downwardly in FIG. 6.

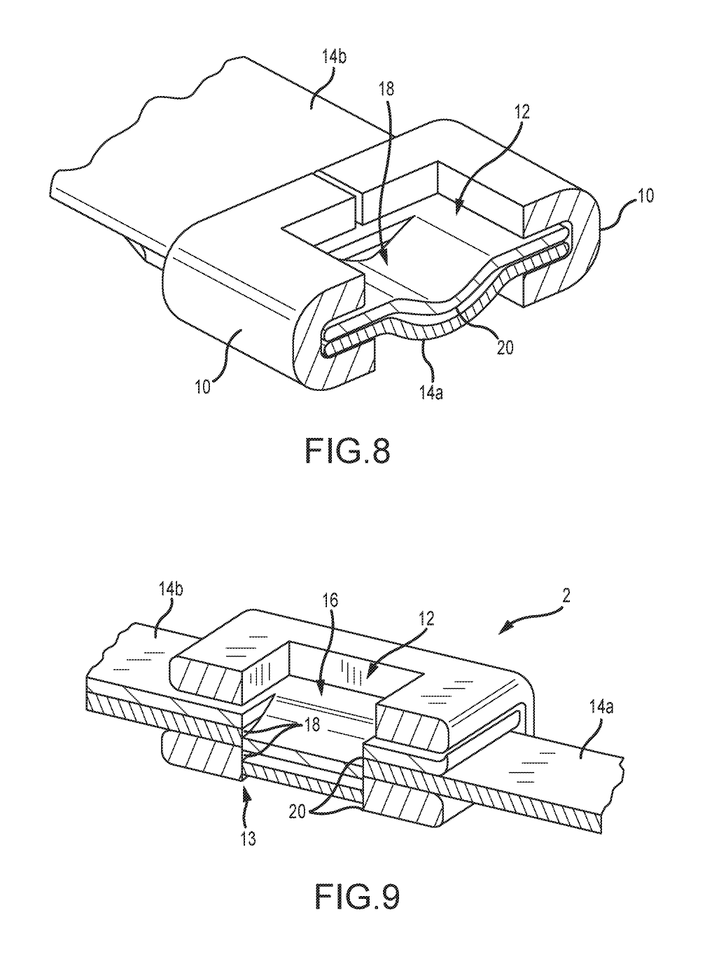

FIGS. 7-8 are cross-sectional perspective views of the embodiment of FIG. 6 which show an interaction between sheared edges of the deformation 16 and the buckle 2 such that the band 14 is restrained within the buckle. As shown in FIGS. 7-8, the deformation 16 provided in a portion of the first end 14a and a portion of the second end 14b of the band 14 produces at least one sidewall or sheared edged 18 that is operable to contact a sidewall 13 of the aperture 12 and substantially prevent movement of the buckle 2 with respect to the band 14. One of ordinary skill in the art will recognize that if no deformation 16 as shown and described herein is provided in the band 14, the ends of the band 14 will be able to freely translate in and out of the buckle. The deformation 16 produces a first sheared edge 18 on both the first end 14a and the second end 14b of the band 14. The deformation 16 also produces a second sheared edge 20 on the first end 14a and the second end 14b of the band 14, and wherein the second sheared edge 20 is provided in opposing relationship to the first sheared edge 18. The sheared edges 18, 20 are provided in force-transmitting communication with an aperture sidewall 13 on both sides of the aperture 12 of the buckle 2.

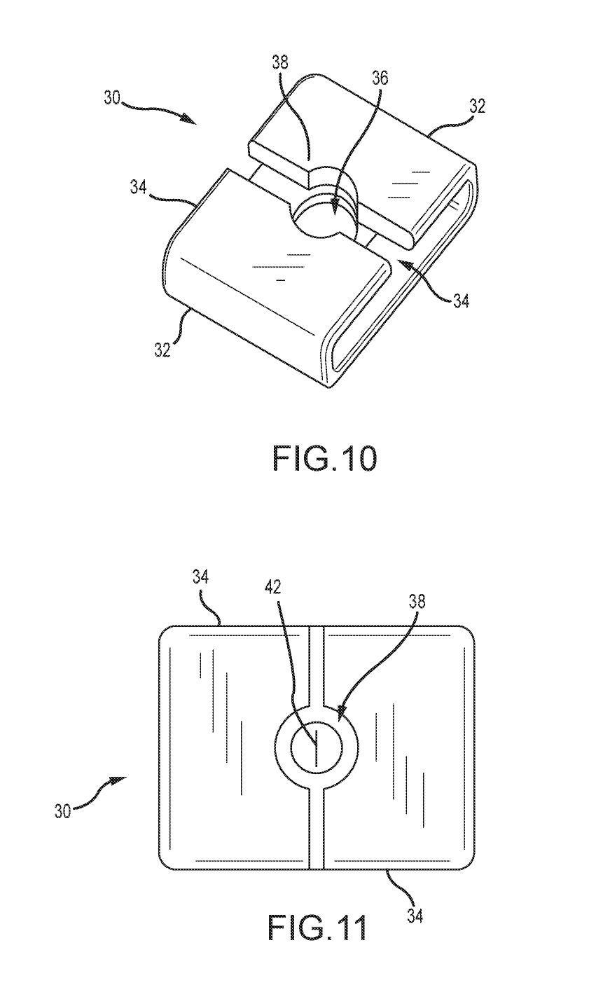

FIG. 10 is a perspective view of a buckle 30 according to another embodiment of the present disclosure. As shown, the buckle 30 comprises a first and second bend 32 to create an at least partially confined volume. The buckle 30 comprises peripheral openings 34 to accept and accommodate a band or strap (for example). The buckle 30 further comprises first and second apertures 36, 38, wherein at least one of the apertures is provided to accommodate a deformation of a band, and at least one of the apertures is provided to receive or accommodate a tool for forming the deformation. The apertures 36, 38 of the embodiment of FIG. 10 comprises substantially circular apertures operable to create and/or accommodate a substantially circular deformation in the band (not shown in FIG. 10). The buckle of FIG. 10 operates under the same principles as the buckle shown in FIG. 1, for example, but comprises different structural and geometric elements as shown in FIG. 10.

FIG. 11 is a bottom plan view of the buckle 30 according to the embodiment of FIG. 10, and wherein a deformation 42 provided in a band extends at least partially in the buckle 30. The deformation 42 comprises at least one of a circular, conical, and a frustoconical depression provided in at least a portion of a band that extends into the buckle 30. Preferably, the deformation 42 is of a size and geometry such that an outer circumference of the deformation 42 extends to make contact with the lower aperture 38 provided in the buckle, and a movement of the band relative to the buckle 30 is substantially prevented.

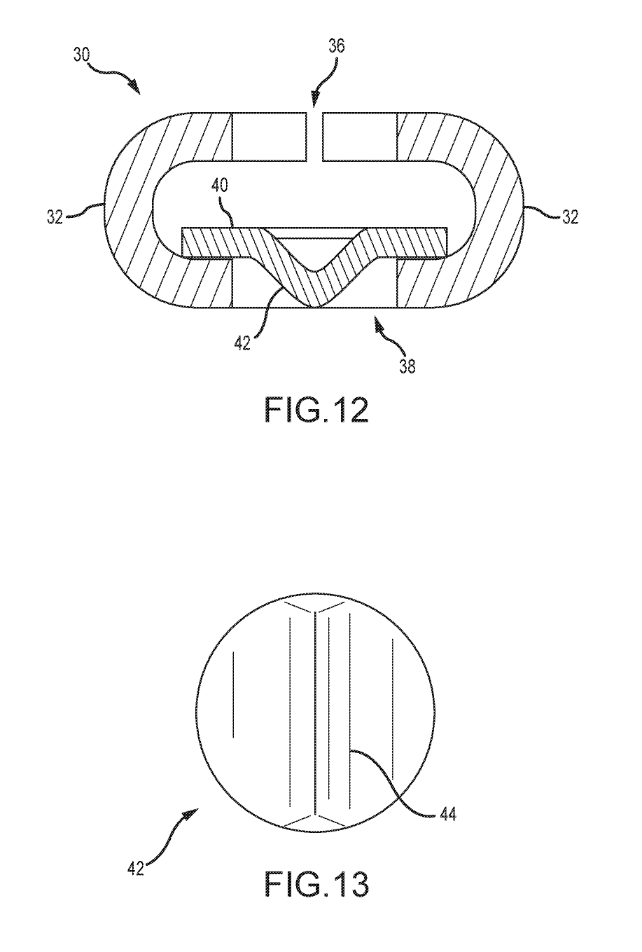

FIG. 12 is a side elevation view of the buckle 30 according to the embodiment of FIG. 10. As shown in FIG. 12, the buckle 30 is provided with a band 40 extending at least partially therethrough. The band 40 is provided with a deformation 42 which extends at least partially into a lower aperture 38 provided in the buckle 30. In various methods of the present invention, a punch is provided and inserted through the upper aperture 36 to deform the band 40 and create a deformation 42 that extends downwardly (at least in FIG. 12). The communication between the deformation 42 and the buckle 30 provides a connection between the two components and substantially fixes the relative position of the buckle 30 and the band 40.

FIG. 13 is a detailed view of the deformation 42 of the band 40. As shown in FIG. 13, the deformation comprises an indentation or depression in the band, and wherein the indentation comprises a ridge 44. The ridge 44, which is preferably formed from the shape of the punch tool comprises and provides an enhanced contact and load-bearing point to provide additional grip or securing strength between the buckle 30 and the band 40.

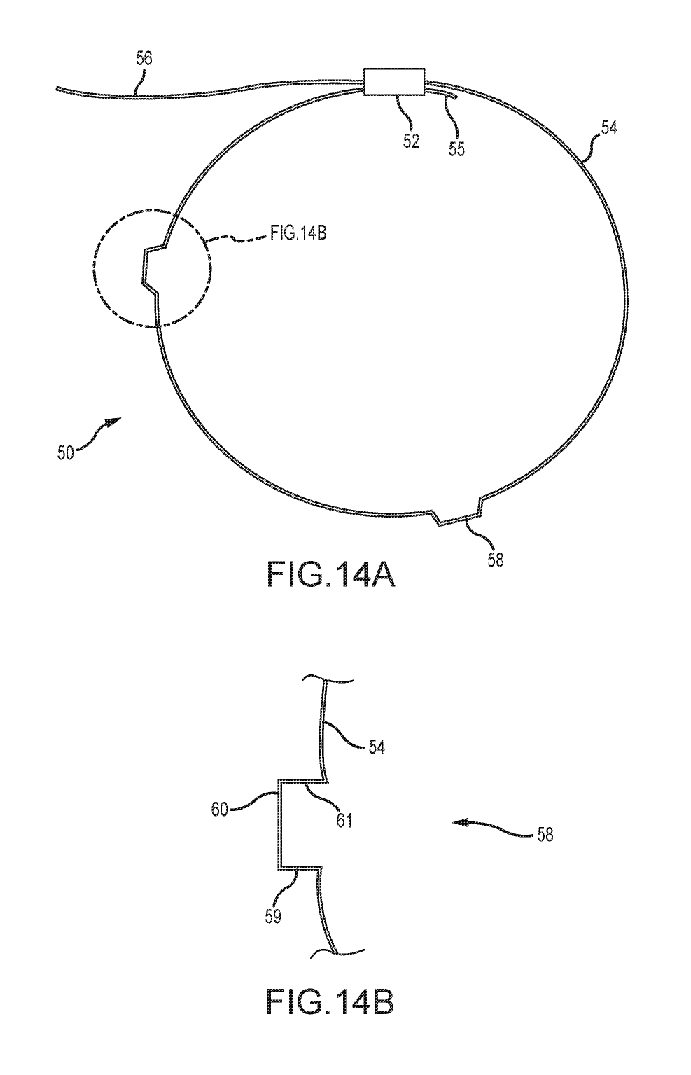

FIG. 14A is an elevation view of a band clamp system 50 according to one embodiment of the present invention, wherein the system 50 comprises a buckle 52 and a band 54. The buckle 52 may comprise any number or combination of buckle features as shown and described herein. The band 54 comprises at least one protrusion 58. In the depicted embodiment of FIG. 14A, the protrusion 58 comprises a diversion of a general path of the band and does not comprise an additional component (such as a welded-on or fastened component). The band 54 comprises a first end 55 and a second end 56 that are preferably wrapped around an additional object or component (not shown) and secured at or to the buckle 52. The ends 55, 56 may be cut, crimped, or altered as desired.

FIG. 14B is a detailed view of a protrusion 58 of the band 54. As shown, the protrusion 58 comprises a step or diversion from a remainder of the band 54. The step is formed of first 59, second 60 and third 61 angled portions. The first and third 59, 61 angled portions may be provided at various angles with respect a main portion of the band 54, and are preferably angled at between approximately 45 degrees and approximately 110 degrees with respect to a remainder of the band 54. The second portion 60 is provided substantially parallel to a tangent line associated with the band 54, at least when the band 54 is provided in a circular arrangement.

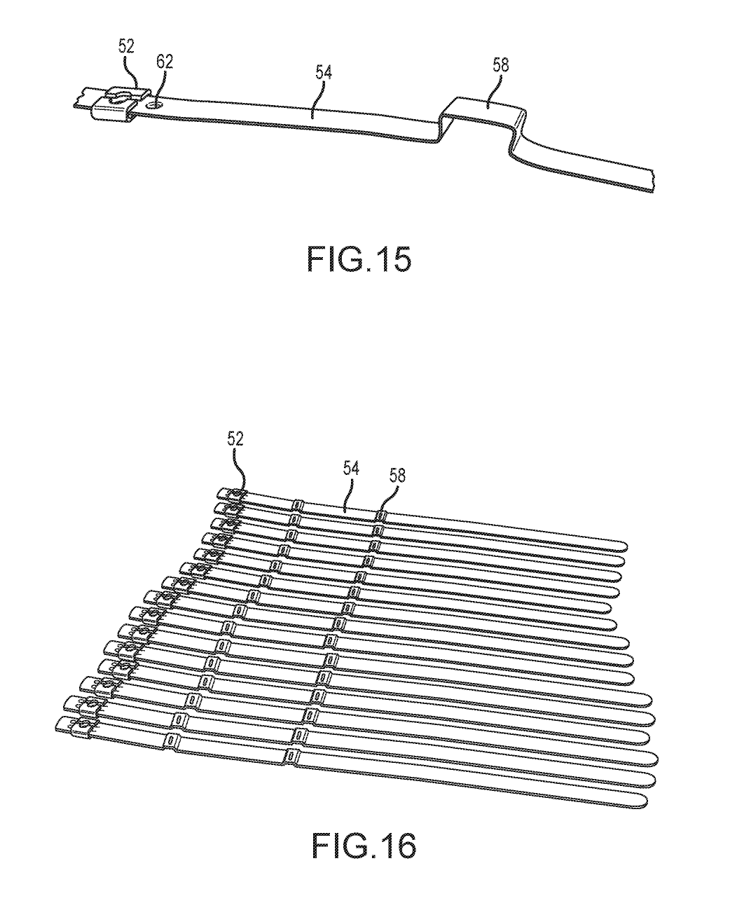

FIG. 15 is a perspective view of a band clamp system according to one embodiment of the present invention, and wherein the system is not provided around or secured to an object. As shown, the band 54 comprises a buckle 52, a deformation 62, and a protrusion 58. The protrusion comprises a pre-formed feature. In other words, the band clamp system is preferably provided or sold with at least one pre-formed protrusion 58 and the system depicted in FIG. 15 is ready for installation or attachment to one or more objects.

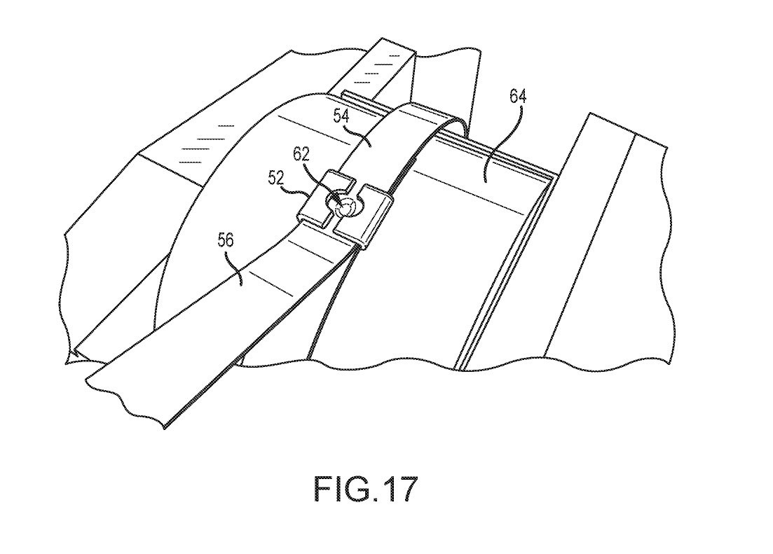

FIG. 16 is a perspective view of a plurality of band clamps including buckles 52, bands 54, and at least one protrusion 58 provided on the band. The devices provided in FIG. 16 are ready for installation. Methods of installing and using the devices of FIG. 15 include providing the band 54 around one or more objects to be secured, passing a second end of the band 54 through the buckle, and securing the band and buckle. After installation, the band and protrusion(s) 58 may be inspected to determine whether or not a change or deformation in the secured object has occurred, such a change being signaled or indicated by a flattening or change in the protrusion(s) 58, at least with respect to the shape and position of the protrusion(s) shown in FIG. 16.

FIG. 17 is a perspective view of a band clamp system provided in combination with an object 64. The object 64 provided in FIG. 17 comprises a generic, substantially cylindrical object and is provided for illustration purposes. Devices of the present invention are contemplated as being provided with various objects, and no limitations with respect to intended uses of band clamps and buckles of the present invention are provided herewith. For example, band clamp systems of the present invention may be provided to secure items to posts or poles, to bind cabling, to secure loads, and to surround flush cartridges in toilets, to name just a few applications.

As shown in FIG. 17, a band 54 is passed around the object 64, such that least a portion of a first end and a second end 56 of the band are provided within the buckle 52. The band, and an associated tension in the band 54, is secured by providing a deformation 62 on a portion of the band 54 disposed within the buckle 52. A free portion of the second end 56 may be cut to length.

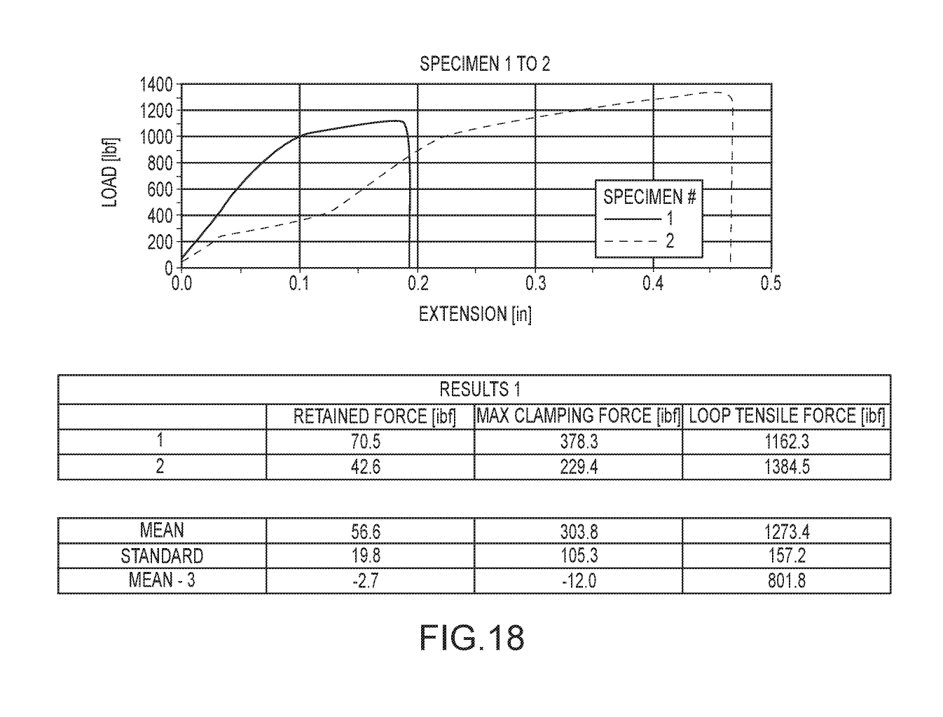

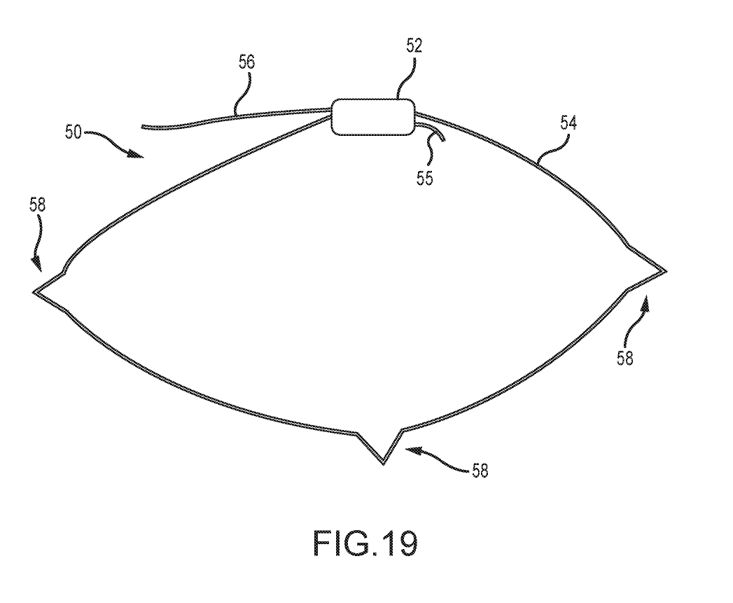

FIGS. 18-19 are stress-strain graphs illustrating performance characteristics of band clamp systems according to different embodiments of the present invention. Referring now to FIG. 18, one of ordinary skill in the art will recognize that applied load (in lb-f) is displayed on the Y-axis, and strain (in inches) is displayed on the X-axis.

As shown in FIG. 18, two specimens are provided. Specimen 1 comprises a band that is devoid of protrusions as shown in FIG. 14A. This basic band, that does not comprise the band features of FIG. 14A exhibits a deformation or strain under load, and a failure point between approximately 1100 lbf and approximately 1200 lbf. The failure point of the embodiment depicted as Specimen 1 generally comprises the buckle, which is designed to fail under tension at a lower strain than a band. As further shown in FIG. 18, Specimen 2 comprises a band according to the embodiment of FIG. 14A, including at least one protrusion 58. At least in part due to the protrusions, Specimen 2 exhibits enhanced load bearing characteristics, including the ability to sustain a greater amount of inelastic deformation and strain than Specimen 2. Additionally, Specimen 2 exhibits a higher overall load capacity, wherein a failure point of Specimen 2 comprises a load of between approximately 1300 lbf and approximately 1500 lbf, and preferably of at least about 1380 lbf.

FIG. 19 is an elevation view of a band clamp system 50 according to another embodiment of the present invention, wherein the system 50 comprises a buckle 52 and a band 54. The buckle 52 may comprise any number or combination of buckle features as shown and described herein. The band 54 comprises at least one protrusion 58. In the depicted embodiment of FIG. 19, the protrusion 58 comprises a diversion of a general path of the band and does not comprise an additional component (such as a welded-on or fastened component). The band 54 comprises a first end 55 and a second end 56 that are preferably wrapped around an additional object or component (not shown) and secured at or to the buckle 52. The ends 55, 56 may be cut, crimped, or altered as desired. In contrast with the embodiment provided in FIG. 14A, the protrusions 58 comprise substantially pointed features which extend from an otherwise curvilinear band member 54. The protrusions 58 comprise first, second and third bends or crimps to form the protrusion, each of which are deformable when the band 54 is expanded. It will be recognized that the protrusions 58 shown and described herein are not limited to any particular shape. Various different protrusions and bends may be provided. In an alternative embodiment, at least one protrusion 58 provided on a band 54 comprises an accordion-like structure, with multiple points of bending where deflection may occur.

Where the term “substantially” is used herein, one of ordinary skill in the art will readily understand the meaning of such a term in its context. For example, the terms “substantially flat” or “substantially circular” will be understood to indicate that minor variations in manufacturing and natural bending of components may alter devices of the present invention such that surface are not exactly flat or objects are not exactly circular.

While various embodiments of the present invention have been described in detail, it is apparent that modifications and alterations of those embodiments will occur to those skilled in the art. It is to be expressly understood that such modifications and alterations are within the scope and spirit of the present invention, as set forth in the following claims. Further, it is to be understood that the invention(s) described herein is not limited in its application to the details of construction and the arrangement of components set forth in the preceding description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

What is claimed is:

1. A band clamp system, comprising:
a buckle for receiving a band, said buckle comprising an aperture through an outer surface of the buckle;
a band positioned within the buckle;
a deformation formed in the band located generally adjacent to the aperture, the deformation preventing relative motion between the band and the buckle;
a curled portion of the band that engages an edge of the buckle and that prevents relative motion of the buckle relative to the band: and the band comprising a length and at least one protrusion provided on the length and distal from the buckle, the protrusion comprising at least one of a bend and a step and wherein the protrusion comprises a departure from a general path of the band.

2. The band clamp system of claim 1, wherein the band and the protrusion are formed from a single piece of material.

3. The band clamp system of claim 1, wherein at least one of the buckle and the band comprises a ferrous material.

4. The band clamp system of claim 1, wherein at least two protrusions are provided on the length of the band.

5. The band clamp system of claim 1, wherein the deformation of the band is provided in force-transmitting communication with at least one sidewall of the buckle to prevent relative motion between the band and the buckle.

6. The band clamp system of claim 1, wherein the deformation comprises at least one sheared edge.

7. The band clamp of claim 1, wherein the band is provided around an object to be secured, and a first end and a second of the band are secured at the buckle by the deformation.

8. A band clamp system, comprising:
a buckle for receiving a band, said buckle comprising at least one peripheral opening for receiving a band, and an aperture through an outer surface of the buckle;
a band positioned within the buckle;
the aperture of the buckle comprising an aperture sidewall, the aperture sidewall operable to be provided in force-transmitting, communication with the band to prevent relative motion of the buckle relative to the band;
the band comprising a length and at least one protrusion provided on the length and distal from the buckle, the protrusion comprising at least one of a bend and a step and wherein the protrusion comprises a departure from a general path of the band.

9. The band clamp system of claim 8, wherein the band and the at least one protrusion are formed from a single piece of material.

10. The band clamp system of claim 8, wherein at least one of the buckle and the band comprises a ferrous material.

11. The band clamp system of claim 8, wherein at least two protrusions are provided on the length of the band.

12. The band clamp system of claim 8, wherein the band comprises a deformation, and wherein the deformation is provided in force-transmitting communication with the aperture sidewall to prevent relative motion between the band and the buckle.

13. The band clamp system of claim 12, wherein the deformation comprises at least one sheared edge.

14. The band clamp system of claim 1, wherein the band is provided around an object to be secured, and a first end and a second of the band are secured at the buckle.

15. A method of securing an object with a band damp, the method comprising:
providing a buckle for receiving a band, said buckle comprising:
an aperture through an outer surface of the buckle, and a band positioned within the buckle; and
the band comprising a length and at least one protrusion provided on the length and distal from the buckle, the protrusion comprising at least one of a bend and a step and wherein the protrusion comprises a departure from a general path of the band;
providing the band around an object to be secured;
inserting a first end and a second end of the band into the buckle;
providing a deformation in the band proximal to the buckle, and Wherein the deformation provides force-transmitting communication between the band and the buckle; and
monitoring the at least one protrusion of the band to determine of the object has experienced a movement or a deformation.

16. The method of claim 15, wherein the deformation is formed with the use of a punch.

17. The method of claim 15, wherein the deformation comprises a sheared edge in the band, and wherein the sheared edge is provided adjacent to a surface of the buckle.

18. The method of claim 15, further comprising applying a predetermined tension to the band prior to providing the deformation.

19. The method of claim 15, wherein the deformation is provided in the first end and the second end of the band.

20. The method of claim 15, wherein a plurality of deformations are provided in the band.
